(19) United States
(12) Patent Application Publication
(10) Pub. No.: US 2004/0157976 A1
(43) Pub. Date: Aug. 12, 2004

(54) Pressure sensitive adhesive for single- or double-sided adhesive sheet strips and process for the preparation hereto

(75) Inventors: Andreas Junghans, Hamburg (DE); Thorsten Krawinkel, Hamburg (DE)

Correspondence Address: Norris, McLaughlin & Marcus P.A., 30th Floor, 220 East 42nd Street, New York, NY, 10017, US

(73) Assignee: tesa Aktiengesellschaft, Hamburg (DE)

(21) Appl. No.: 10/737,211

(22) Filed: Dec. 16, 2003

(30) Foreign Application Priority Data
Dec. 20, 2002 (DE) 102 61 106.8

(51) Int. Cl. C08K 3/04; C08K 3/26; C08K 3/34

(52) U.S. Cl. 524/492; 524/495; 524/425; 524/270

(57) ABSTRACT

A pressure sensitive adhesive for single-sided or double-sided adhesive sheet strips which can be redetached without residue or destruction by extensive stretching in the plane of the bond, composed of a mixture comprising at least one block copolymer and at least one tackifier, wherein the mixture comprises at least one water-soluble polymer.

The invention relates to a pressure sensitive adhesive (PSA) for single- and double-sided adhesive sheet strips which can be redetached without residue or destruction by extensive stretching in the plane of the bond, composed of a mixture comprising at least one block copolymer and at least one tackifier.

The invention further relates to the use of the pressure sensitive adhesive.

### BACKGROUND OF THE INVENTION

Highly elastically or plastically stretchable self-adhesive tapes which can be redetached without residue or destruction by extensive stretching in the plane of the bond are known from, for example, U.S. Pat. No. 4,024,312 A, DE 33 31 016 C2, WO 92/11132 A1, WO 92/11333 A1, DE 42 22 849 C1, WO 95/06691 A1, DE 195 31 696 A1, DE 196 26 870 A1, DE 196 49 727 A1, DE 196 49 728 A1, DE 196 49 729 A1, DE 197 08 364 A1, DE 197 20 145 A1, DE 198 20 858 A1, WO 99/37729 A1 and DE 100 03 318 A1 and are referred to inter alia below as strippable self-adhesive tapes.

Strippable self-adhesive tapes of this kind are frequently used in the form of single- or double-sided adhesive sheet strips, which preferably have a nonadhesive grip region from which the detachment operation is initiated.

Particular applications of such self-adhesive tapes can be found in DE 42 33 872 A1, DE 195 11 288 A1, U.S. Pat. No. 5,507,464 A, U.S. Pat. No. 5,672,402 A and WO 94/21157 A1, with specific embodiments being described in, for example, DE 44 28 587 A1, DE 44 31 914 A1, WO 97/07172 A1, DE 196 27 400 A1, WO 98/03601 A1 and DE 196 49 636 A1, DE 197 20 526 A1, DE 197 23 177 A1, DE 297 23 198 A1, DE 197 26 375 A1, DE 197 56 084 A1, DE 197 56 816 A1, DE 198 42 864 A1, DE 198 42 865 A1, WO 99/31193 A1, WO 99/37729 A1 and WO 99/63018 A1.

The fields of use of aforementioned strippable adhesive sheet strips include in particular the residueless and nondestructive redetachable fixing of light to moderately heavy articles in the home, workplace, and office segments. In these applications they replace conventional fastening means such as, for example, drawing pins, roundhead needles, thumbtacks, nails, screws, conventional self-adhesive tapes, and liquid adhesives. Key to the successful use of the adhesive sheet strips is not only the possibility of residueless and nondestructive redetachment of bonded articles but also their quick and easy bonding and also their secure hold for the envisaged period of bonding. It should be borne in mind in particular here that the adhesive strips must function on a large number of substrates in order to be able to serve as a universal fixing in the home, workplace, and office segments.

Despite the fact that the patent literature cited above describes a broad range of PSAs for use in strippable self-adhesive tapes, commercial products currently on the market (for example, tesa® Powerstrips® from tesa AG, 3M Command® Adhesive Strips from 3M, and Plastofix® Formule Force 1000 Adhesive Strips from Plasto S.A.) all have PSAs based on styrene block copolymers with unsaturated polydiene blocks in the elastomer block.

Typically use is made of linear or radial block copolymers based on polystyrene blocks and polybutadiene blocks and/or polyisoprene blocks: i.e., for example, radial styrene-butadiene (SB)ₙ and/or linear styrene-butadiene-styrene (SBS) and/or linear styrene-isoprene-styrene (SIS) block copolymers. Advantages of aforementioned styrene block copolymer based PSAs for use in strippable self-adhesive tapes are, for example, the very high bond strengths which can be achieved with them (owing, inter alia, to the simultaneous realization of very high cohesion and very high adhesive forces), pronounced reduction in tack during stretching detachment (which greatly facilitates, if not indeed being a precondition for, the operation of detachment), and a very high tensile strength, which is essential in particular for an operation of detachment with no tearing.

The products available on the market, all of which utilize PSAs based on styrene block copolymers, exhibit weaknesses in bond strength under the influence of atmospheric humidity or water. This behavior is particularly pronounced when bonds are made to hydrophilic substrates such as glass or ceramic. Particularly in the case of moisture exposure shortly after the bonding of moderately heavy articles, failure of the PSA strips is a frequent occurrence. The holding power under the influence of moisture is reduced in particular in those PSA strips which comprise nonpolar tackifier resins such as hydrocarbon resins or polyterpene resins.

In the case of products which include an intermediate foam carrier with adhesive applied to both sides thereof, the reduction in bond strength under moisture exposure is more strongly pronounced than in the case of adhesive strips composed of just one layer of adhesive. Failure of the bond occurs in the case of a simple peeling load and particularly in the case of a tipping/shearing load (where a torque is active, as in the case, for example, of bonding of a hook with a particular lever on which something is hung) to a much greater extent than in the case of a plain shearing load.

It is an object of the present invention to present a pressure sensitive adhesive for a single- or double-sided adhesive sheet strip which can be redetached without residue or destruction even from sensitive substrates by extensive stretching essentially parallel to the plane of the bond and which possesses good bond strengths even on hydrophilic substrates such as glass or ceramic and even at elevated atmospheric humidity.

### SUMMARY OF THE INVENTION

This object is achieved by a pressure sensitive adhesive composed of a mixture comprising at least one block copolymer and at least one tackifier, wherein at least one water-soluble polymer has been incorporated into the mixture.

With a large number of pressure sensitive adhesives the bonding performance subsides considerably under the influence of high atmospheric humidity or water. Not only is it the case that damp or wet adhesive strips adhere much less well or even not at all, or that they are difficult to bond to wet substrates, but also existing bonds of an adhesive tape on a substrate can be impaired in their load-bearing capacity, or even fail completely, under the influence of humidity or water. This phenomenon is particularly pronounced in the case of hydrophilic substrates such as glass or ceramic products such as tiles. Ceramic tiles in particular are frequently found in bathrooms or kitchens, where for short periods the atmospheric humidity can rise very greatly. Hydrophilic substrates possess the property of often having a very thin layer of adsorbed water on the surface, which can only be removed at very high temperatures. As a result of this thin water layer it is very easy for humidity or water to be picked up by glass. Owing to the molecular structure of the glass it is even capable of taking water into the glass itself and not only of absorbing it on the surface. Similar considerations apply to ceramic products as well.

If, then, an adhesive tape is bonded to ceramic products or glass, a thin water layer remains between the adhesive tape and the glass. This layer is so thin that the bonding properties of the adhesive tape are unaffected: the bond between adhesive tape and glass can be very strong, similar to that between steel and the same adhesive tape.

If moisture in the form of high atmospheric humidity or water acts on the bond, the water layer between glass and adhesive strip can pick up further water, which causes the layer to grow. Water can also diffuse through the glass to the bond area. Consequently the bond performance is reduced to such an extent that it can lead to the failure of the bond.

For adhesives which adhere effectively even under these conditions it is standard practice to use very soft adhesives which are able to seal all of the pores in the glass, so that the water is no longer able to diffuse into the intermediate layer. This path is taken, for example, in the bonding of laminated glass sheets, where an isobutyl rubber adhesive is employed (according to Skeist, “Handbook of Adhesives”, 2nd edition, 1977).

For strippable systems as described above this path is not possible if the adhesive strips are to offer a very high bond strength and are also to be removable again without destruction by pulling in the plane of the bond. These two properties are only achievable if the adhesive possesses a high cohesion and high tensile strength; in other words, the adhesive must be. formulated to be relatively hard. As a consequence it is not possible for the adhesives described to go so well onto the glass or the ceramic that all of the pores in the glass are sealed. Water is therefore able to penetrate into the space in between and lead to the failure of the bond. This effect is especially pronounced when adhesive strips are used which have an intermediate foam carrier. In this case water or moisture penetrate very much more rapidly than in the case of adhesive strips which are composed only of said adhesive without the use of such an intermediate carrier.

Surprisingly it has been found that as a result of the addition of water-soluble polymers it is possible to bring about a distinct increase in the holding power of the adhesive strips under moisture conditions on hydrophilic substrates.

The water-soluble polymers probably retard penetration of moisture into the interface between PSA strip and substrate.

Water-soluble compounds of this kind may be, for example, sodium salts of polyacrylic acid or polyvinylpyrrolidone. These polymers first begin to swell in water and then dissolve completely in the presence of sufficient water. On exposure to atmospheric humidity or briefly to water the soluble polymers are only swollen: complete dissolution no longer takes place.

### DETAILED DESCRIPTION

In one preferred embodiment of the invention the water-soluble polymers are neither physically nor chemically crosslinked. Noncrosslinked polymers have the advantage that they can be incorporated more effectively into the adhesive, both in the case of an operation from the solution and in the case of compounding from the melt.

The water-soluble polymers are preferably present in a range between 0.5 to 20% by weight and more preferably between 2 to 8% by weight, based on the pressure sensitive adhesive. The addition of small amounts of water-soluble polymers has the advantage that the mechanical and performance properties of the PSA strips on dry substrates are not altered in such a way as to restrict the actual purpose of use.

The water-soluble polymers can be used on different chemical bases, such as, for example, sodium salts of polyacrylic acid, starch-modified polyacrylic acid, polyacrylamides, polysulfonic acid, polyvinylpyrrolidone, polyvinyl alcohol or carboxymethylcellulose. The water-soluble polymers are able to absorb water and to swell. They can be dissolved in part in organic solvents and/or melted by heating, and so can be incorporated well into the adhesives.

The water-soluble polymers are either in solution or dispersion in the adhesive. Since they are present only at a low concentration and undergo virtually no interactions with the other raw materials, they have only little influence on the mechanical properties of PSA strips formed with the PSA. The performance properties in the dry likewise show no influence when these polymers are added.

At a concentration of just 1% by weight of water-soluble polymer, based on the overall adhesive, a reduction is obtained in the sensitivity to moisture. The amount of water-soluble polymer required for sufficient bond performance depends on the nature of the polymer, on the hardness of the adhesive, on the performance capability to be attained, and also on the substrate, to mention but a few of the influences.

The invention further provides for the use of the pressure sensitive adhesive for producing a single-sided and/or double-sided adhesive sheet strip.

Pressure sensitive adhesives used include those based on block copolymers containing polymer blocks formed from vinylaromatics (A blocks), such as styrene, for example, and those formed by polymerization of 1,3-dienes (B blocks), such as butadiene and isoprene, for example. Resultant block copolymers can contain identical or different D blocks, which may be partly, selectively or fully hydrogenated. Block copolymers can have a linear A-B-A structure. It is likewise possible to use block copolymers of radial design and also star-shaped and linear multiblock copolymers. A-B diblock copolymers may be present as a further component. Block copolymers of vinylaromatics and isobutylene are likewise suitable for use. All of the aforementioned polymers can be utilized alone or in a mixture with one another.

Instead of polystyrene blocks it is also possible to utilize polymer blocks based on other aromatics-containing homopolymers and copolymers (C8 to C12 aromatics) having glass transition temperatures of > about 75° C., such as aromatics blocks containing α-methylstyrene, for example. Also suitable for use are polymer blocks based on (meth)acrylate homopolymers and (meth)acrylate copolymers having glass transition temperatures of >75° C. In this context it is possible to employ not only block copolymers whose hard blocks are exclusively those based on (meth)acrylate polymers but also block copolymers which utilize both polyaromatics blocks, such as polystyrene blocks, and poly(meth)acrylate blocks.

Instead of styrene-butadiene block copolymers and styrene-isoprene block copolymers and their hydrogenation products, viz. styrene-ethylene/butylene block copolymers and styrene-ethylene/propylene block copolymers, it is likewise possible to utilize block copolymers and their hydrogenation products which utilize further, polydiene-containing elastomer blocks, such as, for example, copolymers of two or more different 1,3-dienes. Also possible for use are functionalized block copolymers wherein the block copolymer is a maleic anhydride-modified or silane-modified styrene block copolymer.

Typical use concentrations for the block copolymer are situated in the range between 20% and 70% by weight, in particular in the range between 30% and 60% by weight, and more preferably in the range from 35% to 55% by weight.

As further polymers it is possible to use those based on straight hydrocarbons, examples being unsaturated polydienes, such as natural or synthetic polyisoprene or polybutadiene, chemically substantially saturated elastomers, such as a saturated ethylene-propylene copolymer, an a-olefin copolymer, a polyisobutylene, a butyl rubber, an ethylene-propylene rubber, or a chemically functionalized hydrocarbon, such as a polyolefin containing halogen, acrylate or vinyl ether, which are able to replace up to about 100 phr (parts per hundred parts of resin) of the vinylaromatics-containing block copolymers, based on the styrene block copolymer.

The pressure sensitive adhesive can be crosslinked by chemical means, especially radiation-chemical means, for example by UV radiation, or by bombardment with fast electrons.

Pressure sensitive adhesives of the present invention are optionally those whose pressure sensitive adhesion is brought about only by thermal activation or solvent activation.

In addition to those described above based on vinylaromatics-containing block copolymers, suitable pressure sensitive adhesives include all those which have an extension, cohesion, and tensile strength sufficient for the detachment operation. PSAs of this kind can be used alone or in combination with those based on vinylaromatics-containing block copolymers.

The tackifier is a tackifying resin which is compatible with the elastomer block of the styrene block copolymers. Suitable tackifying resins include preferably nonhydrogenated, partly hydrogenated or fully hydrogenated resins based on rosin or on rosin derivatives, hydrogenated polymers of dicyclopentadiene, nonhydrogenated, partly, selectively or fully hydrogenated hydrocarbon resins based on C5, C5/C9 or C9 monomer streams, polyterpene resins based on α-pinene and/or β-pinene and/or δ-limonene, a hydrogenated polymer of pure C8 or C9 aromatics. Aforementioned tackifying resins can be used either alone or in a mixture.

The mixture preferably comprises at least one additive. In order to stabilize the PSAs it is usual to add antioxidants. Additives can be primary or secondary antioxidants; in particular, as primary antioxidants, sterically hindered phenols and, as secondary antioxidants, phosphites or thiols are employed. C-radical scavengers can also be added.

As an additive it is also possible to use light stabilizers, such as UV absorbers or sterically hindered amines, for example. It is likewise possible to add antiozonants, metal deactivators, processing auxiliaries or endblock-reinforcing resins.

Further possible additives include plasticizers. Plasticizers used can be liquid resins, plasticizer oils or low molecular mass liquid polymers, which comprise a low molecular mass polyisobutylene having a molar mass <1 500 g/mol or a liquid EPDM (ethylene/propylene-diene terpolymer) grade with a maximum proportion of 20% by weight.

Fillers, such as silica, glass (ground or in the form of beads), alumina, zinc oxide, calcium carbonate, titanium dioxide or carbon black, to name but a few, and also color pigments and dyes, and optical brighteners, can likewise be used.

Pressure sensitive adhesives of the invention can be used for single-layer self-adhesive tapes redetachable without residue or destruction by extensive stretching (in accordance for example with DE 33 31 016 C2, DE 42 22 849 Cl or WO 98/03601 A1) and also for multilayer self-adhesive tapes with or without an intermediate foam carrier (in accordance for example with DE 197 08 366 A1, DE 198 20 858 A1, WO 92/11333 A1, DE 196 49 727 A1, DE 196 49 728 A1, DE 196 49 729 A1, DE 197 20 145 A1, U.S. Pat. No. 5,516,581 A or WO 95/06691 A1). Where they are used in multilayer self-adhesive tapes in accordance with DE 197 08 366 A1the PSAs form the outer layers of the adhesive strips. Adhesive strips can be shaped in accordance with DE 44 28 587 C2 and U.S. Pat. No. 5,925,459 A and/or modified in accordance with DE 44 31 914 C2. The pressure sensitive adhesive can likewise be utilized in products in accordance with DE 43 39 604 C2.

Suitable intermediate carriers comprise, for example, foam carrier materials (intermediate foam carriers), especially homopolymers and copolymers of ethylene, especially polyethylenes of low and very low density (LDPE, LLDPE, VLDPE), ethylene-vinyl acetate copolymers, and mixtures of aforementioned polymers. Further possible polymers include the following:

polyvinyl acetates, polypropylenes, polyurethanes based on aromatic and aliphatic diisocyanates, polystyrene, impact-modified polystyrenes, PVC, acrylate copolymers. Foams can be employed in crosslinked or noncrosslinked form.

The thicknesses of the foams employed are in particular between 175 μm and 10 mm, preferably between 250 μm and 5 mm, more preferably between 350 μm and 3 mm. Densities are from 20 to 400 kg/m³, preferably from 25 to 250 kg/m³, more preferably from 25 to 150 kg/m³. The foam structure can be a closed-cell, open-cell or mixed-cell structure. Both skinned and nonskinned foams of integral or nonintegral structure can be utilized. In accordance with the invention it is likewise possible to use laminates of two or more foams.

In order to achieve sufficient anchoring of the PSAs used on the foams they are advantageously subjected to a pretreatment during the production process and/or prior to their coating with PSA. Suitable pretreatment methods include fluorine pretreatment, corona pretreatment, plasma pretreatment and flame pretreatment, the latter in particular by means of electrically polarized flames. Pretreatment methods can be employed alone or in combination. In the case of skinned foams and integral foams the foam can be primed in order to improve further the anchoring of the adhesive.

Open-cell and mixed-cell foams can be subjected to impregnation. As an option it is possible to integrate between foam and PSAs a barrier layer in order to reduce the migration of migratable materials between PSAs and foam.

### Preparation of the PSAs

The preparation and processing of the pressure sensitive adhesives can take place from solution and from the melt. It has proven advantageous to manufacture the adhesive from the melt. For the latter case, suitable production operations include both batch processes and continuous processes. Particularly appropriate here is the continuous manufacture of the pressure sensitive adhesive by means of an extruder.

### Converting

Typical converted forms of the self-adhesive tapes utilizing the PSA of the invention are adhesive tape rolls and adhesive strips, such as are obtained in the form of diecuts, for example. Diecuts optionally include a nonadhesive grip tab region starting from which the detachment operation can be performed.

Single-sided self-adhesive tapes can be obtained here, for example, by neutralizing one side of aforementioned double-sided self-adhesive tapes or self-adhesive strips.

In the text below the invention is explained in more detail with reference to examples, without wishing thereby to restrict the invention in any form whatsoever.

As described above, PSA strips consisting of the following constituents are produced:

### EXAMPLE 1

| | | | |
|---|---|---|---|
| 100 | parts | Kraton D 1165 | SIS with 30% block |
| | | | polystyrene content |
| | | | from Kraton |
| | | | Polymers |
| 100 | parts | Escorez 1310 | HC resin having a |
| | | | softening point of |
| | | | 94° C. from Exxon |
| 0.5 | part | Irganox 1010 | Aging inhibitor |
| | | | from Ciba-Geigy |
| 5 | parts | Pigmentverteiler N | Sodium salt of |
| | | [pigment dispersant] | polyacrylic acid |
| | | | from BASF |

### COMPARATIVE EXAMPLE C1

| | | | |
|---|---|---|---|
| 100 | parts | Kraton D 1165 | SIS with 30% block |
| | | | polystyrene content |
| | | | from Kraton |
| | | | Polymers |
| 100 | parts | Escorez 1310 | HC resin having a |
| | | | softening point of |
| | | | 94° C. from Exxon |
| 0.5 | part | Irganox 1010 | Aging inhibitor |
| | | | from Ciba-Geigy |

### EXAMPLE 2

| | | | |
|---|---|---|---|
| 100 | parts | Vector 8508 | SBS with 30% block |
| | | | polystyrene content |
| | | | from Dexco |
| 100 | parts | Piccolyte A 115 | α-Pinene resin |
| | | | having a softening |
| | | | point of 115° C. |
| | | | from Hercules |
| 0.5 | part | Irganox 1010 | Aging inhibitor |
| | | | from Ciba-Geigy |
| 5 | parts | Rhodoviol | Polyvinyl alcohol |
| | | | from Rhodia PPMC |

### COMPARATIVE EXAMPLE C2

| | | | |
|---|---|---|---|
| 100 | parts | Vector 8508 | SBS with 30% block |
| | | | polystyrene content |
| | | | from Dexco |
| 100 | parts | Piccolyte A 115 | α-Pinene resin |
| | | | having a softening |
| | | | point of 115° C. |
| | | | from Hercules |
| 0.5 | part | Irganox 1010 | Aging inhibitor |
| | | | from Ciba-Geigy |

TABLE 1
Mechanical and performance data

| | | Stripping | | Tip-shear |
|---|---|---|---|---|
| | Tensile strength | tension | Peel rate | stability time |
| Example | in MPa | in MPa | in mm/24 h | in days |
| 1 | 8.7 | 1.6 | 17 | 24 |
| C1 | 8.4 | 1.6 | 20 | 27 |
| 2 | 13.6 | 2.3 | 16 | >60 |
| C2 | 13.0 | 2.1 | 13 | >60 |

Table 1 shows mechanical and performance data for the examples described above. As can be seen from the values measured for the comparative examples the water-soluble polymer has no influence on the mechanical properties or on the performance properties in adhesive bonds under dry conditions.

TABLE 2
Bond performances under moisture exposure

| | | Tip-shear |
|---|---|---|
| | Peel rate in | stability time |
| | mm/24 h under | in days |
| Example | moisture | under moisture |
| 1 | 15 | 10 |
| C1 | >40 | <1 |
| 2 | 24 | >30 |
| C2 | >40 | 3 |

Table 2 shows bond performances under exposure to moisture conditions. Through the addition of a water-soluble polymer the bond performances under the influence of moisture on hydrophilic substrates have been significantly improved. Even small amounts are enough to obtain the desired effect.

The mechanical and performance data were determined as follows:

### Tensile Strength and Maximum Elongation

The tensile strength and maximum elongation were measured in a method based on DIN 53504 using dumbbells of size S3 at a separation rate of 300 mm per minute.

### Detachment Force

The detachment force (stripping force or stripping stress) was determined using an adhesive sheet measuring 50 mm long ×20 mm wide with a nonadhesive grip tab region at the top end. The adhesive sheet was bonded between two steel plates, arranged congruently with one another and measuring 50 mm×30 mm, using an applied pressure of 50 newtons in each case. At their bottom end the steel plates each have a bore to accommodate an S-shaped steel hook. The lower end of the steel hook carries a further steel plate which allows the test arrangement to be fixed in the lower clamping jaw of a tensile testing machine for the purpose of measurement. The adhesive bonds are stored at +40° C. for a duration of 24 hours. After reconditioning to room temperature the adhesive sheet strip is detached with a pulling speed of 1 000 mm per minute parallel to the bond plane and without contact with the edge regions of the two steel plates. During this procedure the required detachment force is measured, in newtons (N). The figure reported is the average value of the stripping stress values (in N per mm²), measured in the range in which the adhesive strip has undergone detachment from the steel substrates over a bonding length of between 10 mm and 40 mm.

### Peel Strength

For the determination of the peel strength the PSA strip specimens for investigation are laminated over the entire area of one side with a 23 μm PET film (Hostaphan RN 25; Mitsubishi Chemicals, for example) without air bubbles. After this has been done the second adhesive sheet strip side is covered at one end with a film strip (again Hostaphan RN 25) about 6 mm long, thereby forming at this end a nonadhesive grip tab region on both sides. Thereafter the adhesive sheet strip under test is bonded by its front side, using gentle finger pressure, to the test substrate (coated woodchip wallpaper: wallpaper=Erfurt Körning 52, color=Herbol Zenit LG, wallpaper bonded to compressed chipboard). The PSA samples are then pressed for 10 seconds at an applied pressure of 90 N per 10 cm² of bond area and thereafter are conditioned at 40° C. for 15 minutes. The test plates are then fixed horizontally so that the adhesive strip is pointing downward. Using a clamp (20 g), a 50 g weight is fastened to the nonadhesive grip tab, so that the resulting peel load (approximately 0.7 N per 20 mm of adhesive strip width) acts orthogonally to the bond plane. After a test phase of 15 minutes, and a repeat after 24 hours, a mark is made at the distance over which the adhesive strip has peeled away from the bond substrate since the beginning of the test. The distance between the two marks is recorded as the peel path (unit: mm per 24 hours).

### Tip-Shear Strength

For the determination of the tip-shear strength the adhesive sheet under test, measuring 20 mm×50 mm and provided at one end on both sides with a nonadhesive grip tab region (obtained by laminating on a 25 μm biaxially oriented polyester film measuring 20 mm×13 mm (Hostaphan RN 25)), is bonded to the center of a highly polished square steel plate measuring 40 mm long×40 mm wide×3 mm thick. On its back the steel plate is provided centrally with a 10 cm steel rod which sits vertically on the surface of the plate. The test specimens obtained are bonded to the test substrate (steel) with a force of 100 N, with a press-on time of 5 seconds, and are left in the unloaded state for 5 minutes. After the chosen tip-shear load has been applied by attaching a suspended weight (20 N in the case of a 50 mm lever arm) a measurement is made of the time which elapses until the bond fails (i.e., tip-shear stability time). The test conditions are 23° C. with a relative humidity of 50%.

### Tip-Shear Strength (Tip-Shear Stability Times) Under Moisture Conditions

The measurement of the tip-shear strength under the influence of moisture is made as described above with the exception that the measurement is conducted at a relative humidity of 85% and at a temperature of 35° C. The test substrates used are sheets of window glass 4 mm thick, cleaned beforehand with ethyl acetate and ethanol. Adhesive bonding and sample preparation is identical with the determination of the tip-shear strength under standard conditions. The load used is a weight of 10 N with a lever of 50 mm.

### Peel Strength Under Moisture Conditions

The measurement of the peel strength under the influence of moisture is made as described above for peel strength with the exception that the measurement is conducted at a relative humidity of 85% and at a temperature of 35° C. The test substrates used are sheets of window glass 4 mm thick, cleaned beforehand with ethyl acetate and ethanol. Adhesive bonding and sample preparation is identical with the determination of the peel strength under standard conditions. The load is 70 g. The peel path is determined in mm/24 h.

### Production of the Test Specimens

### Production of the PSA Strips

Pressure sensitive adhesives are processed to a homogeneous mixture in a heatable compounder with sigma blades (Werner & Pfleiderer LUK 1,0 K3 equipped with an LTH 303 thermostat from mgw LAUDA) at a temperature of about 160 to 180° C. under carbon dioxide as inertizing gas. After cooling, the adhesive is extruded for about 10 minutes at from 120 to 140° C. (temperature-controllable press: model KHL 50 from Bucher-Guyer) to produce single-layer adhesive sheet sections 700 μm thick (50 μm average value (2-fold standard deviation)). Single-layer PSA strips of the desired dimensions are obtained by die-cutting. Where multilayer PSA strips are produced the corresponding layers are joined beforehand by laminating (hot laminating where appropriate) and subsequently the adhesive strips are individualized by die-cutting.

We claim:

1. A pressure sensitive adhesive for single-sided or double-sided adhesive sheet strips which is redetachable from a substrate without residue or destruction by stretching in the plane of the bond, comprising a mixture of at least one block copolymer, at least one tackifier, and at least one water-soluble polymer.

2. The adhesive as claimed in claim 1, wherein said water-soluble polymer is present in an amount of from 0.5 to 20% by weight, based on the weight of adhesive.

3. The adhesive as claimed in claim 2, wherein said amount of water-soluble polymer is from 2 to 8% by weight, based on the weight of adhesive.

4. The adhesive as claimed in claim 1, wherein said water-soluble polymer is selected from the group consisting of sodium salts of polyacrylic acids, starch-modified polyacrylic acids, polyacrylamides, polysulfonic acids, polyvinylpyrrolidone, polyvinyl alcohol and carboxymethylcellulose.

5. The adhesive as claimed in claim 1, 2, 3 or 4, wherein said mixture further comprises at least one additive selected from the group consisting of antioxidants, light stabilizers and plasticizers.

6. The adhesive as claimed in claim 1, 2, 3 or 4, wherein said mixture further comprises at least one filler selected from the group consisting of silica, glass (ground or in the form of beads), alumina, zinc oxide, calcium carbonate, titanium dioxide and carbon black.

7. A single-sided or double-sided adhesive sheet strip comprising the pressure sensitive adhesive of claim 1, 2, 3 or 4.
